(19) United States
(12) Patent Application Publication
(10) Pub. No.: US 2026/0101326 A1
(43) Pub. Date: Apr. 9, 2026

(54) PERFORMANCE IMPROVEMENT AT SLEEP EXITS FOR FREQUENCY SPUR CHANNELS

(71) Applicant: QUALCOMM Incorporated, San Diego, CA (US)

(72) Inventors: Irina Merin BABY, Kochi (IN); Kapil BHATTAD, Bangalore (IN); Sreya G, Kayamkulam (IN); Srinidhi NAGARAJA, Bengaluru (IN)

(21) Appl. No.: 18/910,830

(22) Filed: Oct. 9, 2024

(51) Int. Cl. H04W 72/115; H04B 17/309; H04W 40/00

(52) U.S. Cl. CPC H04W 72/115; H04B 17/346; H04W 40/005

(57) ABSTRACT

Methods, systems, and devices for wireless communications are described. Generally, the described techniques may enable a user equipment (UE) to disable a sleep mode or awake from sleep earlier for channels or bandwidths that have a frequency spur compared to channels or bandwidths without a frequency spur. Awaking from sleep earlier may enable a band stop filter of the UE to receive more samples to suppress the frequency spur and reduce sensitivity degradation of the UE for decoding control messages. The UE may disable the sleep mode or wake earlier based on a signal-to-noise ratio (SNR) of received signal, a magnitude of the frequency spur, a coding rate of the control message, a bandwidth of the control message, or any combination thereof.

### FIELD OF TECHNOLOGY

The following relates to wireless communications, including performance improvement at sleep exits for frequency spur channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more control messages indicating, based on a presence or absence of a grant in the one or more control messages, a first sleep configuration for a channel associated with the UE and indicating a first sleep duration associated with the first sleep configuration for the channel, selecting a second sleep configuration for the channel based on a presence of a frequency spur in one or more frequencies associated with the channel, the second sleep configuration corresponding to a second sleep duration shorter than the first sleep duration, and monitoring, in an awake state, the channel after the second sleep duration based on the second sleep configuration.

A UE for wireless communications is described. The UE may include one or more memories storing processor executable code, and one or more processors coupled with the one or more memories. The one or more processors may individually or collectively be operable to execute the code to cause the UE to receive one or more control messages indicating, based on a presence or absence of a grant in the one or more control messages, a first sleep configuration for a channel associated with the UE and indicating a first sleep duration associated with the first sleep configuration for the channel, select a second sleep configuration for the channel based on a presence of a frequency spur in one or more frequencies associated with the channel, the second sleep configuration corresponding to a second sleep duration shorter than the first sleep duration, and monitor, in an awake state, the channel after the second sleep duration based on the second sleep configuration.

Another UE for wireless communications is described. The UE may include means for receiving one or more control messages indicating, based on a presence or absence of a grant in the one or more control messages, a first sleep configuration for a channel associated with the UE and indicating a first sleep duration associated with the first sleep configuration for the channel, means for selecting a second sleep configuration for the channel based on a presence of a frequency spur in one or more frequencies associated with the channel, the second sleep configuration corresponding to a second sleep duration shorter than the first sleep duration, and means for monitoring, in an awake state, the channel after the second sleep duration based on the second sleep configuration.

A non-transitory computer-readable medium storing code for wireless communications is described. The code may include instructions executable by one or more processors to receive one or more control messages indicating, based on a presence or absence of a grant in the one or more control messages, a first sleep configuration for a channel associated with the UE and indicating a first sleep duration associated with the first sleep configuration for the channel, select a second sleep configuration for the channel based on a presence of a frequency spur in one or more frequencies associated with the channel, the second sleep configuration corresponding to a second sleep duration shorter than the first sleep duration, and monitor, in an awake state, the channel after the second sleep duration based on the second sleep configuration.

Some examples of the method, UEs, and non-transitory computer-readable medium described herein may further include operations, features, means, or instructions for receiving, via the channel, one or more second control messages based on the monitoring, suppressing the frequency spur based on monitoring the channel after the second sleep duration and before an end of the first sleep duration, and decoding the one or more second control messages based on suppressing the frequency spur.

Some examples of the method, UEs, and non-transitory computer-readable medium described herein may further include operations, features, means, or instructions for obtaining one or more samples of the channel after the second sleep duration and before the end of the first sleep duration, the second sleep duration associated with a sample quantity threshold and filtering the channel in accordance with the one or more samples, where the frequency spur may be suppressed based on the one or more samples satisfying the sample quantity threshold.

Some examples of the method, UEs, and non-transitory computer-readable medium described herein may further include operations, features, means, or instructions for disabling a sleep mode of the UE in accordance with the second sleep configuration and operating in the awake state during an entirety of the first sleep duration based on disabling the sleep mode in accordance with the second sleep configuration.

Some examples of the method, UEs, and non-transitory computer-readable medium described herein may further include operations, features, means, or instructions for receiving one or more messages based on the monitoring, suppressing a zero-frequency tone based on monitoring the channel after the second sleep duration and before an end of the first sleep duration, and decoding the one or more messages based on suppressing the zero-frequency tone.

In some examples of the method, UEs, and non-transitory computer-readable medium described herein, the second sleep configuration may be selected based on a signal-to-noise ratio (SNR), a received signal strength indicator (RSSI) value, an aggregation level associated with one or more messages, a magnitude of the frequency spur, channel bandwidth, or any combination thereof, satisfying a threshold. In some examples of the method, UEs, and non-transitory computer-readable medium described herein, the channel may be a control channel and the second sleep configuration may be selected based on an overlap of the frequency spur with the one or more frequencies associated with the control channel.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support performance improvement at sleep exits for frequency spur channels in accordance with one or more aspects of the present disclosure.

FIG. 3 shows an example of a time-frequency filter diagram that supports performance improvement at sleep exits for frequency spur channels in accordance with one or more aspects of the present disclosure.

FIG. 4 shows an example of a process flow that supports performance improvement at sleep exits for frequency spur channels in accordance with one or more aspects of the present disclosure.

FIGS. 5 and 6 show block diagrams of devices that support performance improvement at sleep exits for frequency spur channels in accordance with one or more aspects of the present disclosure.

FIG. 7 shows a block diagram of a communications manager that supports performance improvement at sleep exits for frequency spur channels in accordance with one or more aspects of the present disclosure.

FIG. 8 shows a diagram of a system including a device that supports performance improvement at sleep exits for frequency spur channels in accordance with one or more aspects of the present disclosure.

FIGS. 9 and 10 show flowcharts illustrating methods that support performance improvement at sleep exits for frequency spur channels in accordance with one or more aspects of the present disclosure.

### DETAILED DESCRIPTION

In some wireless communications systems, a user equipment (UE) may enter a sleep mode to conserve power. In some examples, the UE may enter the sleep mode based on whether a physical downlink control channel (PDCCH) message indicates an upcoming physical downlink shared channel (PSDCH) message (e.g., whether the PDCCH message indicates data for the UE). For example, the UE may enter the sleep mode for a first duration based on the PDCCH message not indicating a PDSCH message for the UE during at least the first duration. In some cases, a frequency spur (e.g., an unwanted tone) may occur in a channel or bandwidth used for conveying or transmitting the PDCCH message.

Spurs (e.g., a frequency spur) may result from one or more harmonic frequencies of various components in the UE, such as an analog-to-digital converter (ADC), digital-to-analog converter (DAC), a crystal oscillator (XO), and the like. A frequency spur may degrade an ability of a UE to receive and decode downlink messages, such as a PDCCH message. In some cases, a frequency spur may result in data loss because the UE may unsuccessfully decode the PDCCH message that includes information for decoding one or more PDSCH messages. In some systems, a UE may suppress a frequency spur using a band stop filter (e.g., a notch filter). The band stop filter may suppress, or cancel-out, the frequency spur using multiple samples of the channel, or bandwidth, in which the frequency spur is present. As a UE enters (e.g., activates) and exits (e.g., deactivates) the sleep mode, the band stop filter may reset and the accuracy of the filter may degrade (at least until multiple samples of the channel or bandwidth are obtained by the UE). That is, at sleep exit (e.g., as the UE transitions from a sleep state to an awake/active state), the UE may be unable to effectively suppress the frequency spur, which may result in data loss and performance degradation.

The techniques described herein enable a UE to disable a sleep mode or awake from sleep earlier for channels (e.g., bands, subbands, frequencies) that may be associated with or may be subject to a frequency spur. Awaking from sleep earlier in these channels (e.g., compared to channels or bandwidths without a frequency spur) may enable a UE to receive more samples to suppress the frequency spur for the band stop filter and reduce sensitivity degradation of the UE. That is, waking earlier for channels with frequency spurs enables the band stop filter to converge prior to receiving a PDCCH message (which may contain control information for the UE, such as control information indicating one or more upcoming messages for the UE). Further, disabling the sleep mode (e.g., preventing the UE from entering a sleep mode) for channels or bandwidths with frequency spurs enables the UE to suppress the frequency spur because the band stop filter is not reset and remains converged. In some cases, the UE may disable the sleep mode or wake earlier based on a signal-to-noise ratio (SNR), a received signal strength, a magnitude of the frequency spur, a coding rate of the PDCCH message, a bandwidth of the PDCCH message, or any combination thereof.

Aspects of the disclosure are initially described in the context of wireless communications systems. Aspects of the disclosure are further illustrated by and described with reference to a time-frequency filter diagram and a process flow. Aspects of the disclosure are further illustrated by and described with reference to apparatus diagrams, system diagrams, and flowcharts that relate to performance improvement at sleep exits for frequency spur channels.

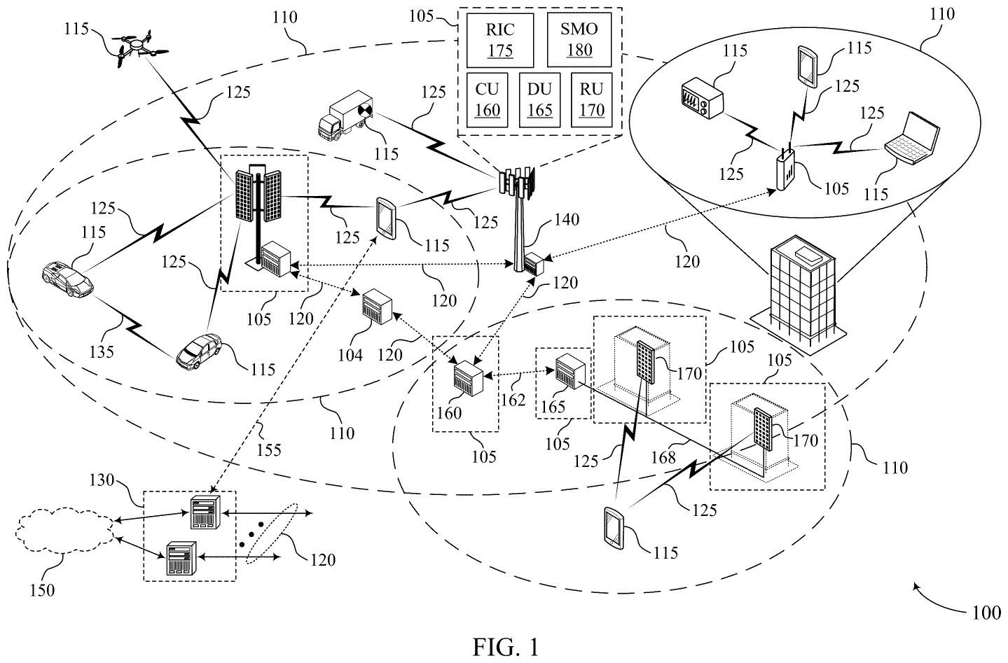

FIG. 1 shows an example of a wireless communications system 100 that supports performance improvement at sleep exits for frequency spur channels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support performance improvement at sleep exits for frequency spur channels as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” or “channel bandwidth” of the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a UE 115 may enter a sleep mode to conserve power. In some examples, the UE 115 may enter the sleep mode based on whether a PDCCH message indicates an upcoming PDSCH message (e.g., whether the PDCCH message indicates data for the UE 115). For example, the UE 115 may enter the sleep mode for a first duration based on the PDCCH message not indicating a PDSCH message for at least the first duration. In some cases, a frequency spur (e.g., an unwanted tone) may occur in a channel or bandwidth of the PDCCH message.

Frequency spurs (e.g., a frequency spur) may result from one or more harmonic frequencies of various components in the UE 115, such as an ADC, a DAC, an XO, or the like. A frequency spur may degrade the UE 115's ability to receive and decode downlink messages, such as a PDCCH message. In some cases, frequency spur may result in data loss because the UE 115 may unsuccessfully decode the PDCCH message that includes information for decoding one or more PDSCH messages. In some systems, a UE 115 may suppress a frequency spur using a band stop filter (e.g., a notch filter). The band stop filter may suppress, or cancel-out, the frequency spur using multiple samples of the channel, or bandwidth, the frequency spur occurs in. Based on entering and exiting the sleep mode, the band stop filter may reset and the accuracy of the filter may degrade. That is, at sleep exit, the UE 115 may not effectively suppress the frequency spur, which may result in data loss.

The techniques described herein enable a UE 115 to disable a sleep mode or awake from sleep earlier for channels that have a frequency spur. Awaking from sleep earlier (e.g., compared to channels or bandwidths without a frequency spur) may enable the UE 115 to receive more samples for a band stop filter to suppress the frequency spur and reduce sensitivity degradation of the UE 115. That is, awaking earlier for channels with frequency spurs enables the band stop filter to converge prior to receiving message for the UE 115 (e.g., a control message such as a PDCCH). Disabling the sleep mode for channels or bandwidths with frequency spurs enables the UE 115 to suppress the frequency spur because the band stop filter is not reset and remains converged. The UE 115 may disable the sleep mode or wake earlier based on an SNR, a received signal strength, a magnitude of the frequency spur, a coding rate of the PDCCH message, a bandwidth of the PDCCH message, or any combination thereof.

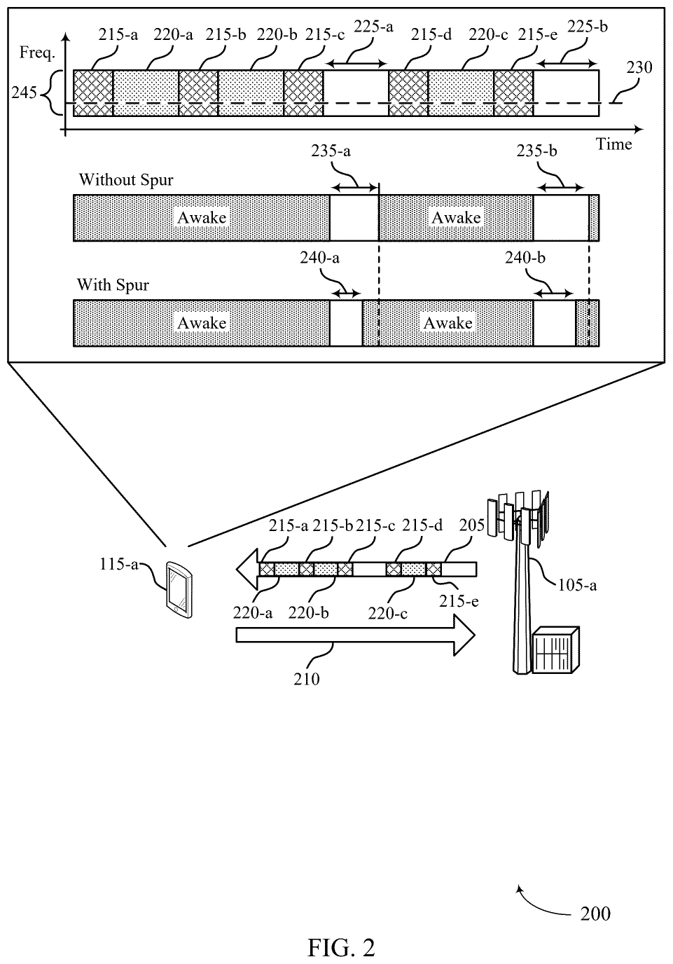

FIG. 2 shows an example of a wireless communications system 200 that supports performance improvement at sleep exits for frequency spur channels in accordance with one or more aspects of the present disclosure. The wireless communications system 200 may implement, or may be implemented by, aspects of the wireless communications system 100, as described herein with reference to FIG. 1. For example, the wireless communications system 100 may include a UE 115-a and a network entity 105-a, which may be examples of the corresponding devices described herein, including with reference to FIG. 1. In some examples, the UE 115-a may receive one or more downlink transmissions 205, transmit one or more uplink transmissions 210, or both.

The one or more downlink transmissions 205 may include one or more PDCCH messages 215, one or more PDSCH messages 220, or a combination thereof. A PDCCH message 215 may include downlink control information (DCI) that the UE 115-a may use to decode one or more PDSCH messages 220 that may be scheduled by one or more respective control messages, such as PDCCH message 215. DCI may include resource allocation information, grant scheduling information (e.g., uplink or downlink grants), modulation and coding scheme information, among other examples, associated with the one or more PDSCH messages 220. The one or more PDSCH messages 220 may include user data sent from the network entity 105-a to the UE 115-a.

In some examples, the UE 115-a may enter a sleep mode (e.g., a low-power mode). A sleep mode may include a sleep duration 235 in which a wireless transceiver (WTR), digital transceiver (DTR), or both, are turned off in the UE 115-a (e.g., to conserve power). For example, the UE 115-a may enter the sleep mode based on whether a decoded PDCCH message 215 indicates absence of a downlink grant message. That is, the UE 115-a may receive and decode a first PDCCH message 215-a or a second PDCCH message 215-b. Based on the first PDCCH message 215-a indicating a first PDSCH message 220-a (e.g., or the second PDCCH message 215-b indicating a second PDSCH message 220-b), the UE 115-a may not enter the sleep mode. The UE 115-a may receive and decode a third PDCCH message 215-c. The third PDCCH message 215-c may indicate a duration 225-a in which no downlink transmission is scheduled for the UE 115-a (e.g., the third PDCCH message 215-c may not indicate a PDSCH message 220). Based on the indication of the duration 225-a, the UE 115-a may enter the sleep mode. Additionally, or alternatively, the UE 115-a may enter the sleep mode based on operating in a TDD mode (e.g., the UE 115-a may sleep based on downlink/uplink switch) or based on switching to a low power mode with an ADC rate change.

In some examples, a frequency spur 230 (e.g., a frequency spurious tone) may be present in a frequency within a bandwidth of the one or more PDCCH messages 215. That is, a respective PDCCH message 215 may span across multiple frequencies (e.g., that define a bandwidth 245), and a frequency spur 230 may occur in one or more of the multiple frequencies. In this example, the frequency spur 230 is shown in one frequency. The frequency spur 230 may occur based on a combination of operating frequencies of one or more components of the UE 115-a. For example, the UE 115-a may include an ADC, a DAC, a phase-lock loop (PLL), or an XO, among other examples, that may operate at different frequencies. Harmonic frequencies or combinations of harmonic frequencies of the ADC, DAC, PLL, and/or XO may cause the frequency spur 230. Because the frequency spur 230 is caused by the harmonic frequencies of the one or more components of the UE 115-a, the UE 115-a may determine (e.g., calculate or compute) the location of frequency spur 230 (e.g., the frequency or tone of the frequency spur 230) prior to receiving the one or more PDCCH messages 215.

In some examples, the frequency spur 230 may degrade decoding performance of the one or more PDCCH messages 215, the one or more PDSCH messages 220, or both. For example, if a magnitude of the frequency spur 230 exceeds a threshold (e.g., greater than a noise floor of a signal or message), the frequency spur 230 may cause sensitivity degradation (e.g., SNR degradation). The UE 115-a may use a band stop filter (e.g., a notch filter) to suppress (e.g., mitigate or cancel-out) the frequency spur 230. That is, the band stop filter may decrease the magnitude of the frequency spur 230 to reduce or prevent sensitivity degradation. In some examples, the UE 115-a may enable the band stop filter based on a received signal power of the one or more PDCCH messages 215 and/or PDSCH messages 220 satisfying a threshold (e.g., based on the received signal power being less than the threshold).

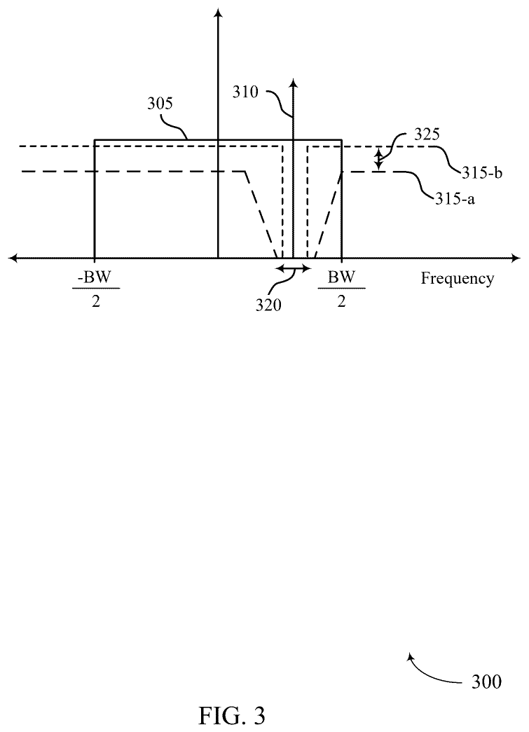

As described further with reference to FIG. 3, the band stop filter may be an infinite impulse response (IIR) filter that continuously estimates and suppresses (e.g., cancels) frequency spurs based on a quantity of samples (e.g., samples from the channel or bandwidth with the frequency spur 230). Based on not receiving a threshold quantity of samples (e.g., when a UE 115-a is in a sleep state or transitioning from a sleep state to an awake state), the band stop filter may inaccurately suppress the frequency spur 230, resulting in a residual amount of the frequency spur 230 remaining (residual frequency spur). That is, the magnitude of the frequency spur 230 after filtering may result in sensitivity degradation of the UE 115-a if the band stop filter is not converged. If the band stop filter receives the threshold quantity of samples, the band stop filter may converge and may accurately suppress the frequency spur 230. That is, an output of the band stop filter may settle or converge to a stable value that cancels-out the frequency spur 230 or suppresses the magnitude of the frequency spur 230 such that the frequency spur 230 does not degrade the sensitivity of the UE 115-a (e.g., a magnitude of the residual frequency spur may be below a threshold).

The UE 115-a may reset a status of the band stop filter while in the sleep mode (e.g., the samples used for convergence of the band stop filter may be dropped or reset). At sleep exit, the band stop filter may begin convergence as the UE 115-a receives samples of the channel. However, in some other wireless communication systems, the band stop filter may not converge (e.g., receive the threshold quantity of samples) in a duration between wake-up and decoding an incoming control message. For example, a UE 115-a may exit the sleep mode to decode a control message, but a residual frequency spur may result in the UE 115-a erroneously decoding the control message and the UE 115-a may lose data indicated by the control message (e.g., the UE 115-a may not decode a data message).

The techniques described herein may enable the UE 115-a to wake-up from sleep earlier, or disable the sleep mode, for bands or channels with the frequency spur 230 so that the band stop filter may converge to suppress the frequency spur 230. For example, the UE 115-a may determine a presence of the frequency spur 230 within a bandwidth of the third PDCCH message 215-c. Based on determining the presence of the frequency spur 230 (e.g., and determining that the third PDCCH message 215-c indicates an absence of a grant for at least the duration 225-a), the UE 115-a may select a first short sleep duration 240-a that is lesser relative to the sleep duration 235-a. For example, the sleep duration 235-a may be used for bands or channels without the frequency spur 230. Accordingly, the UE 115-a may enter the sleep mode after a control message portion (e.g., after the third PDCCH message 215-c) of the duration 225-a based on a processing time of the UE 115-a, and the UE 115-a may wake earlier than the sleep duration 235-a to enable the band stop filter to converge and suppress the frequency spur 230. Additionally, or alternatively, the short sleep durations 240 may be zero. That is, the UE 115-a may disable the sleep mode based on the presence of the frequency spur 230. Based on disabling the sleep mode (e.g., a zero sleep duration), the band stop filter may effectively suppress the frequency spur 230 because the band stop filter was not reset between awake durations.

In a second example, the UE 115-a may select a second short sleep duration 240-b (e.g., which may be the same duration as the first short sleep duration 240-a) based on not receiving or detecting a grant in the duration 225-b (e.g., a fourth PDCCH message 215-d may indicate a third PDSCH message 220-c, while a fifth PDCCH message 215-e may not indicate a PDSCH message 220 in the duration 225-b). The second short sleep duration 240-b may be lesser than the sleep duration 235-b. For example, the sleep duration 235-b may be a sleep duration for a band or channel without a frequency spur (e.g., without the frequency spur 230). In some examples, the first short sleep duration 240-a and the second short sleep duration 240-b may be based on a duration for the band stop filter to converge. That is, each length of the short sleep durations 240 and may be based on a duration for the band stop filter to receive the threshold quantity of samples and converge (e.g., sleep exit may be advanced by at least the notch filter time constant).

In some examples, the UE 115-a may select a short sleep duration 240 (e.g., the first short sleep duration 240-a and/or the second short sleep duration 240-b) based on a low SNR of the received signal. For example, a short sleep duration 240 may be a function of an SNR, a received signal strength indicator (RSSI) value, gain state at the UE 115-a, or any combination thereof. That is, the UE 115- may disable the sleep mode or reduce the sleep duration (e.g., reduce the sleep duration 235) based on an SNR or RSSI value that is below a threshold or based on one or more gain states. Additionally, or alternatively, the UE 115-a may select a short sleep duration 240 based on a magnitude of the frequency spur 230. For example, the UE 115-a may select the short sleep duration 240 based on the frequency spur 230 degrading sensitivity performance of the UE 115-a below a performance threshold. That is, a short sleep duration 240 may be a function of frequency spur power, and the UE 115-a may disable or reduce a sleep duration based on a frequency spur power exceeding a threshold.

In some other examples, the UE 115-a may select a short sleep duration 240 based on a channel coding rate of the one or more PDCCH messages 215. For example, the short sleep duration 240 may be a function of aggregation level of a control signal, such as the one or more PDCCH messages 215. The UE 115-a may disable or reduce the sleep duration based on an aggregation level satisfying (e.g., being below) a threshold. In some cases, the UE 115-a may disable or reduce the sleep duration based on one or more aggregation levels for past slots (e.g., since aggregation level may dynamically change). Additionally, or alternatively, the UE 115-a may select a short sleep duration 240 based on SNR and aggregation level (e.g., when SNR or aggregation level is relatively low). For example, the UE 115-a may disable or reduce the sleep duration at low SNR (e.g., SNR below a threshold) for all aggregation levels. In another example, the UE 115-a may disable or reduce the sleep duration at high SNR (e.g., SNR above the threshold) for relatively low aggregation levels (e.g., aggregation levels below a threshold).

In some examples, the UE 115-a may select a short sleep duration 240 based on a bandwidth of the one or more PDCCH messages 215. Sensitivity degradation caused by frequency spurs at lower bandwidths (e.g., 1.4 MHz) may be relatively higher compared to frequency spurs at higher bandwidths. Based on the frequency spur 230 occurring at lower bandwidths, the UE 115-a may select the first short sleep duration 240-a, the second short sleep duration 240-b, or both. In some cases, the one or more PDCCH messages 215 may occupy an entire carrier bandwidth. In other cases, the one or more PDCCH messages 215 may occupy a portion of the entire bandwidth. In such cases, the short sleep duration 240 may be a function of control signal allocation. That is, the UE 115-a may disable or reduce the sleep duration based on a control channel overlapping with the frequency spur 230. For example, the UE 115-a may select the first short sleep duration 240-a based on a control channel allocation for the third PDCCH message 215-c overlapping with the frequency spur 230. If there is no overlap between the control channel and the frequency spur 230, the UE 115-a may select the sleep duration 235-a and/or the sleep duration 235-b.

In some examples, the frequency spur 230 may occur at zero frequency (e.g., a DC tone). For example, the zero-frequency spur may be caused by coupling between a local oscillator of the UE 115-a and one or more radio-frequency ports of the UE 115-a (e.g., irrespective of band or channel of operation). In such examples, the UE 115-a may use a wideband DC (WBDC) filter for DC cancellation (e.g., similar to the band stop filter). The WBDC filter may estimate and cancel a DC tone (e.g., the frequency spur 230) from received samples (e.g., the WBDC filter may be an IIR filter). In some cases, the UE 115-a may initialize the WBDC filter with a seed value. The seed value may increase the speed at which the WBDC filter converges (e.g., seed values close to the DC level enables the filter to converge faster), however valid seed values may be estimated from past samples for a same gain state. That is, at sleep exit, the WBDC filter may restart and a seed value may be unavailable. As described herein, the UE 115-a may select the short sleep duration 240 (e.g., waking earlier or disabling sleep), which may enable the WBDC to converge and prevent degradation from residual DC tones. That is, disabling or reducing the sleep duration may prevent SNR degradation caused by residual DC at sleep exit in examples where a seed value may be unavailable.

FIG. 3 shows an example of a time-frequency filter diagram 300 that supports performance improvement at sleep exits for frequency spur channels in accordance with one or more aspects of the present disclosure. The time-frequency filter diagram 300 may implement or be implemented by aspects of the wireless communications systems 100 or 200, as described with reference to FIGS. 1 and 2. For example, the time-frequency filter diagram 300 includes a control signal 305 and a frequency spur 310, which may be examples of a PDCCH message 215 and the frequency spur 230, described with reference to FIG. 2. In the time-frequency filter diagram 300, a UE (such as the UE 115-a described with reference to FIG. 2) may receive the control signal 305 over a bandwidth that includes the frequency spur 230. The UE may suppress the frequency spur 310 using a band stop filter 315.

The band stop filter 315 (e.g., a notch filter) may be an IIR filter. That is, the band stop filter 315 may use samples (e.g., of past output values) to suppress, or cancel-out, the frequency spur 310. The band stop filter 315 may attenuate signals, such as the frequency spur 310, within a frequency range, the stopband 320, while allowing signals outside of the range (e.g., the control signal 305) to pass through with minimal, or no, attenuation. The stopband may be centered around the frequency of the frequency spur 310, which may enable suppression of the frequency spur 310 without significantly degrading decoding performance of the control signal 305.

As the band stop filter 315 uses more samples, its accuracy in suppressing the frequency spur 310 may improve. For example, a non-converged band stop filter 315-a may have a wider stopband 320 relative to a converged band stop filter 315-b (e.g., a wider stopband may suppress portions of the control signal 305). A non-converged band stop filter may also have a reduced magnitude 325 compared to a converged band stop filter 315-b, which may result in a residual frequency spur after filtering the frequency spur 310. The non-converged band stop filter 315-a may become the converged band stop filter 315-b based on receiving a threshold quantity of samples.

As described herein, the UE may disable or reduce a sleep duration to enable the band stop filter 315 to receive more samples (e.g., to converge), which may enable the band stop filter to effectively suppress the frequency spur 310 (e.g., compared to the non-converged band stop filter 315-a). That is, disabling the sleep mode or waking earlier, in accordance with a short sleep duration 240 as described with reference to FIG. 2, may enable the band stop filter 315 to receive the threshold quantity of samples to converge prior to receiving the control signal 305. Accordingly, the UE may suppress the frequency spur 310 using the converged band stop filter 315-b, receive the control signal 305, and decode the control signal 305 with reduced sensitivity degradation.

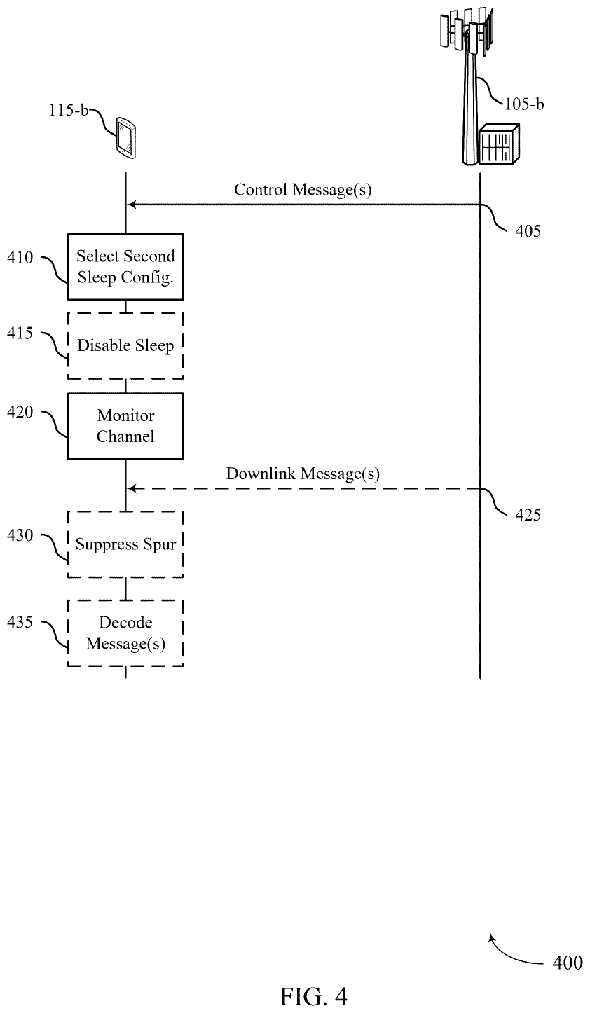

FIG. 4 shows an example of a process flow 400 that supports performance improvement at sleep exits for frequency spur channels in accordance with one or more aspects of the present disclosure. The process flow may implement or be implemented by aspects of any of the wireless communications systems or the time-frequency filter diagram described with reference to FIGS. 1 through 3. For example, the process flow 400 includes a network entity 105-b and a UE 115-b, which may be examples of corresponding devices described herein, including with reference to FIGS. 1 and 2. In the following description of the process flow 400, operations between the network entity 105-b and the UE 115-b may be added, omitted, or performed in a different order (with respect to the exemplary order shown).

At 405, the UE 115-b may receive one or more control messages (e.g., one or more PDCCHs) indicating, based on a presence or absence of a grant in the one or more control messages, a first sleep configuration for a channel associated with the UE 115-a and indicating a first sleep duration associated with the first sleep configuration for the channel. For example, the one or more control messages may indicate the UE 115-a to enter a sleep mode for the first sleep duration based on an absence of a grant in the one or more control messages. That is, the UE 115-b may enter the sleep mode based on decoding the one or more control messages and determining that there are no upcoming (e.g., for at least the first sleep duration) downlink or uplink messages, such as one or more PDSCH messages or one or more PUSCH messages. In some examples, the channel may be a control channel.

At 410, the UE 115-b may select a second sleep configuration for the channel based at least in part on a presence of a frequency spur in one or more frequencies associated with the channel. For example, the UE 115-b may select the second sleep configuration based on an SNR, an RSSI value, an aggregation level associated with the one or more messages, a magnitude of the frequency spur, the channel bandwidth, or any combination thereof. The second sleep configuration may correspond to a second sleep duration shorter than the first sleep duration. In some cases, the UE 115-b may select the second sleep configuration based on an overlap of the frequency spur with the one or more frequencies associated with the control channel.

In some examples, at 415, the UE 115-b may disable the sleep mode of the UE 115-b in accordance with the second sleep configuration. For example, the second sleep duration may be zero, and the UE 115-b may not enter sleep (e.g., the sleep mode may be disabled) based on the second sleep duration being zero. That is, the UE 115-b may operate in an awake state during an entirety of the first sleep duration based on disabling the sleep mode in accordance with the second sleep configuration.

At 420, the UE 115-b may monitor, in the awake state, the channel after the second sleep duration based on the second sleep configuration. For example, the UE 115-b may enter the sleep mode based on receiving a control message that indicates an absence of a grant in accordance with selecting the second sleep configuration. Based on an expiration of the second sleep duration, the UE 115-b may wake-up (e.g., exit the sleep mode) and monitor the channel. At 425, the UE 115-b may receive, via the channel, one or more downlink messages based on the monitoring. The one or more downlink messages may include one or more second control messages, one or more downlink data messages, or any combination thereof.

At 430, the UE 115-b may suppress the frequency spur based on monitoring the channel after the second sleep duration and before the end of the first sleep duration. That is, the UE 115-b may suppress the frequency spur based on waking earlier than the end of first sleep duration, which may enable a band stop filter of the UE 115-b to receive more samples and converge, as described with reference to FIG. 3. For example, the UE 115-b may obtain one or more samples of the channel after the second sleep duration and before the end of the first sleep duration, the second sleep duration associated with a sample quantity threshold. The UE 115-b may filter the channel (e.g., using the band stop filter) in accordance with the one or more samples, where the frequency spur is suppressed based on the one or more samples satisfying the sample quantity threshold. Additionally, or alternatively, the UE 115-b may suppress a zero-frequency tone (e.g., DC tone) based on monitoring the channel after the second sleep duration and before an end of the first sleep duration.

At 435, the UE 115-b may decode the one or more downlink messages (e.g., the one or more second control messages) based on suppressing the frequency spur. That is, the UE 115-b may not accurately decode the one or more second control messages if the UE 115-b did not monitor the channel after the second sleep duration and before the end of the first duration (e.g., a residual frequency spur after the band stop filter may degrade decoding performance).

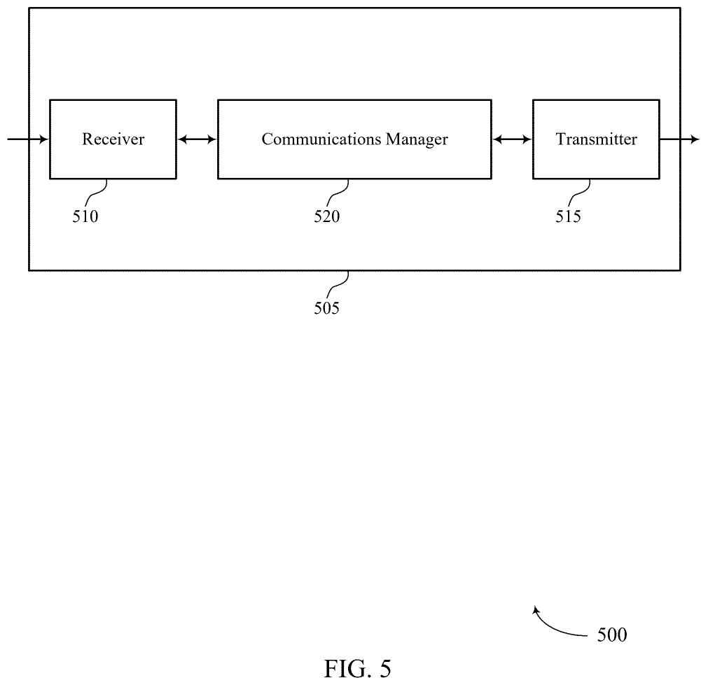

FIG. 5 shows a block diagram 500 of a device 505 that supports performance improvement at sleep exits for frequency spur channels in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to performance improvement at sleep exits for frequency spur channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to performance improvement at sleep exits for frequency spur channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of performance improvement at sleep exits for frequency spur channels as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving one or more control messages indicating, based on a presence or absence of a grant in the one or more control messages, a first sleep configuration for a channel associated with the UE and indicating a first sleep duration associated with the first sleep configuration for the channel. The communications manager 520 is capable of, configured to, or operable to support a means for selecting a second sleep configuration for the channel based on a presence of a frequency spur in one or more frequencies associated with the channel, the second sleep configuration corresponding to a second sleep duration shorter than the first sleep duration. The communications manager 520 is capable of, configured to, or operable to support a means for monitoring, in an awake state, the channel after the second sleep duration based on the second sleep configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption, and more efficient utilization of communication resources, among other examples.

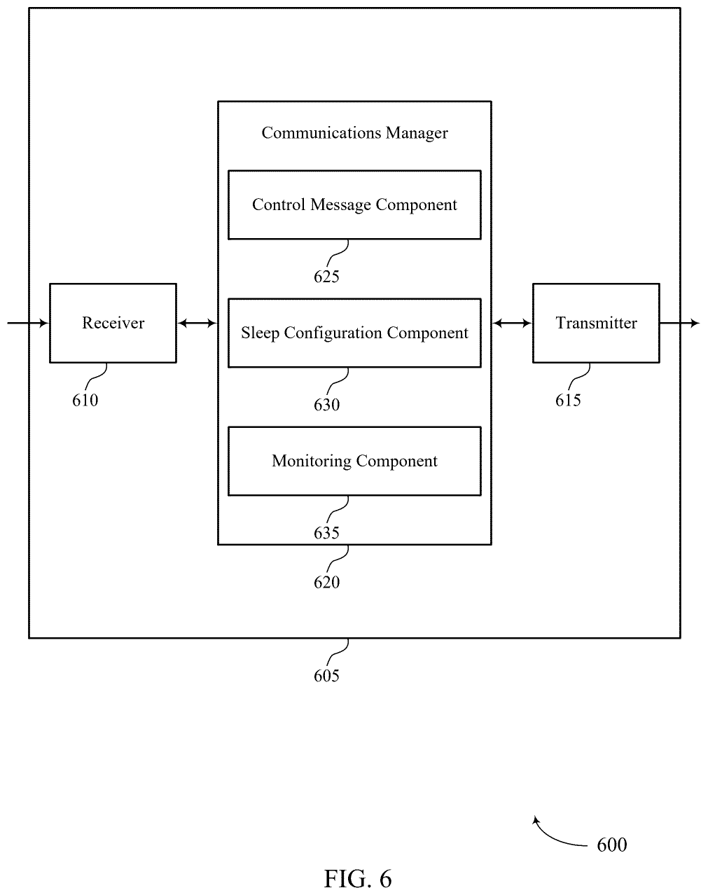

FIG. 6 shows a block diagram 600 of a device 605 that supports performance improvement at sleep exits for frequency spur channels in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to performance improvement at sleep exits for frequency spur channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to performance improvement at sleep exits for frequency spur channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of performance improvement at sleep exits for frequency spur channels as described herein. For example, the communications manager 620 may include a control message component 625, a sleep configuration component 630, a monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control message component 625 is capable of, configured to, or operable to support a means for receiving one or more control messages indicating, based on a presence or absence of a grant in the one or more control messages, a first sleep configuration for a channel associated with the UE and indicating a first sleep duration associated with the first sleep configuration for the channel. The sleep configuration component 630 is capable of, configured to, or operable to support a means for selecting a second sleep configuration for the channel based on a presence of a frequency spur in one or more frequencies associated with the channel, the second sleep configuration corresponding to a second sleep duration shorter than the first sleep duration. The monitoring component 635 is capable of, configured to, or operable to support a means for monitoring, in an awake state, the channel after the second sleep duration based on the second sleep configuration.

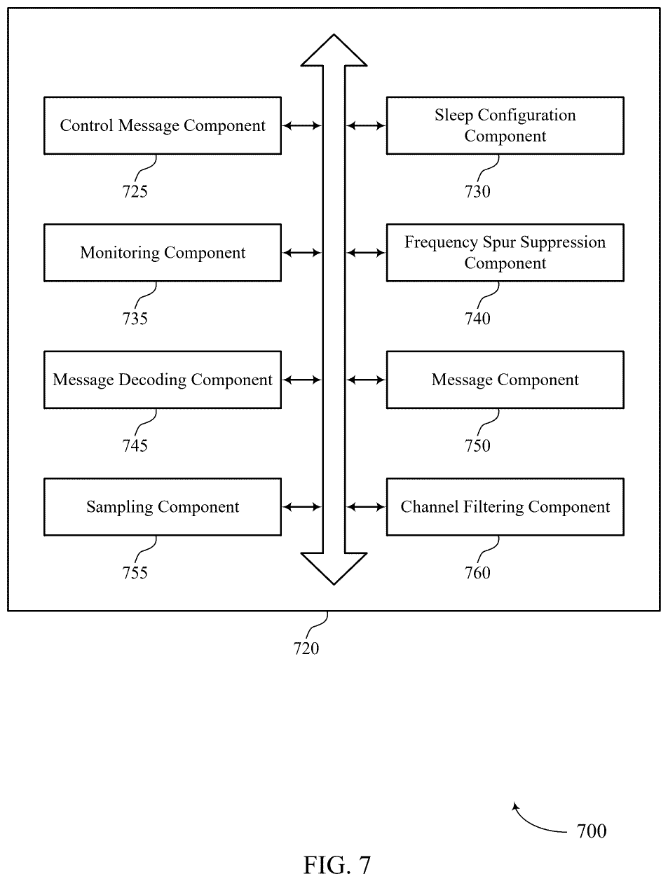

FIG. 7 shows a block diagram 700 of a communications manager 720 that supports performance improvement at sleep exits for frequency spur channels in accordance with one or more aspects of the present disclosure. The communications manager 720 may be an example of aspects of a communications manager 520, a communications manager 620, or both, as described herein. The communications manager 720, or various components thereof, may be an example of means for performing various aspects of performance improvement at sleep exits for frequency spur channels as described herein. For example, the communications manager 720 may include a control message component 725, a sleep configuration component 730, a monitoring component 735, a frequency spur suppression component 740, a message decoding component 745, a message component 750, a sampling component 755, a channel filtering component 760, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control message component 725 is capable of, configured to, or operable to support a means for receiving one or more control messages indicating, based on a presence or absence of a grant in the one or more control messages, a first sleep configuration for a channel associated with the UE and indicating a first sleep duration associated with the first sleep configuration for the channel. The sleep configuration component 730 is capable of, configured to, or operable to support a means for selecting a second sleep configuration for the channel based on a presence of a frequency spur in one or more frequencies associated with the channel, the second sleep configuration corresponding to a second sleep duration shorter than the first sleep duration. The monitoring component 735 is capable of, configured to, or operable to support a means for monitoring, in an awake state, the channel after the second sleep duration based on the second sleep configuration.

In some examples, the control message component 725 is capable of, configured to, or operable to support a means for receiving, via the channel, one or more second control messages based on the monitoring. In some examples, the frequency spur suppression component 740 is capable of, configured to, or operable to support a means for suppressing the frequency spur based on monitoring the channel after the second sleep duration and before an end of the first sleep duration. In some examples, the message decoding component 745 is capable of, configured to, or operable to support a means for decoding the one or more second control messages based on suppressing the frequency spur.

In some examples, the sampling component 755 is capable of, configured to, or operable to support a means for obtaining one or more samples of the channel after the second sleep duration and before the end of the first sleep duration, the second sleep duration associated with a sample quantity threshold. In some examples, the channel filtering component 760 is capable of, configured to, or operable to support a means for filtering the channel in accordance with the one or more samples, where the frequency spur is suppressed based on the one or more samples satisfying the sample quantity threshold.

In some examples, the sleep configuration component 730 is capable of, configured to, or operable to support a means for disabling a sleep mode of the UE in accordance with the second sleep configuration. In some examples, the sleep configuration component 730 is capable of, configured to, or operable to support a means for operating in the awake state during an entirety of the first sleep duration based on disabling the sleep mode in accordance with the second sleep configuration.

In some examples, the message component 750 is capable of, configured to, or operable to support a means for receiving one or more messages based on the monitoring. In some examples, the frequency spur suppression component 740 is capable of, configured to, or operable to support a means for suppressing a zero-frequency tone based on monitoring the channel after the second sleep duration and before an end of the first sleep duration. In some examples, the message decoding component 745 is capable of, configured to, or operable to support a means for decoding the one or more messages based on suppressing the zero-frequency tone.

In some examples, the second sleep configuration is selected based on a signal-to-noise ratio, a received signal strength indicator value, an aggregation level associated with one or more messages, a magnitude of the frequency spur, channel bandwidth, or any combination thereof, satisfying a threshold. In some examples, the channel is a control channel. In some examples, the second sleep configuration is selected based on an overlap of the frequency spur with the one or more frequencies associated with the control channel.

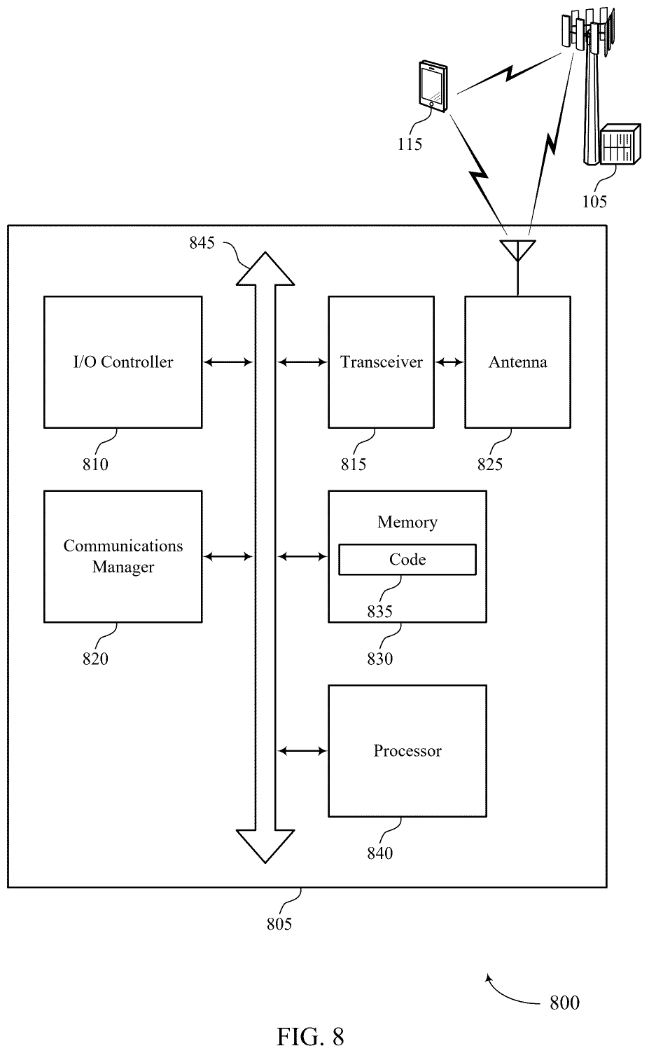

FIG. 8 shows a diagram of a system 800 including a device 805 that supports performance improvement at sleep exits for frequency spur channels in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting performance improvement at sleep exits for frequency spur channels). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving one or more control messages indicating, based on a presence or absence of a grant in the one or more control messages, a first sleep configuration for a channel associated with the UE and indicating a first sleep duration associated with the first sleep configuration for the channel. The communications manager 820 is capable of, configured to, or operable to support a means for selecting a second sleep configuration for the channel based on a presence of a frequency spur in one or more frequencies associated with the channel, the second sleep configuration corresponding to a second sleep duration shorter than the first sleep duration. The communications manager 820 is capable of, configured to, or operable to support a means for monitoring, in an awake state, the channel after the second sleep duration based on the second sleep configuration.

By including or configuring the communications manager 820 in accordance with examples as described herein, the device 805 may support techniques for improved communication reliability, improved user experience related to reduced processing, reduced power consumption, more efficient utilization of communication resources, and longer battery life, among other examples.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of performance improvement at sleep exits for frequency spur channels as described herein, or the at least one processor 840 and the at least one memory 830 may be otherwise configured to, individually or collectively, perform or support such operations.

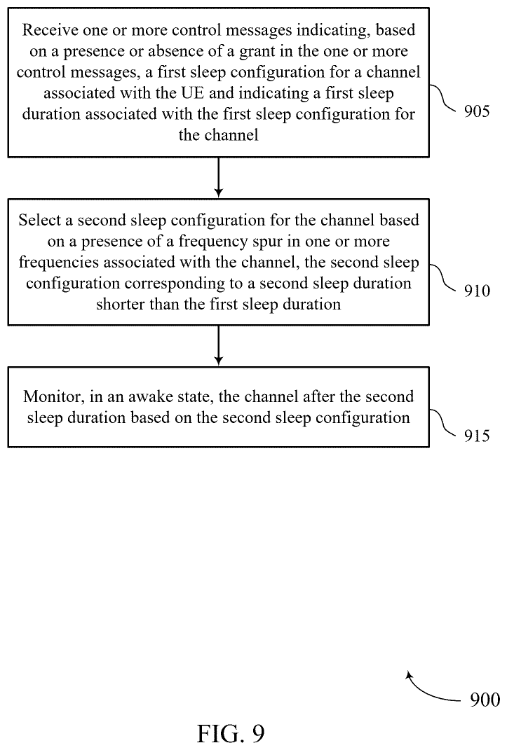

FIG. 9 shows a flowchart illustrating a method 900 that supports performance improvement at sleep exits for frequency spur channels in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving one or more control messages indicating, based on a presence or absence of a grant in the one or more control messages, a first sleep configuration for a channel associated with the UE and indicating a first sleep duration associated with the first sleep configuration for the channel. The operations of 905 may be performed in accordance with examples as disclosed herein. In some examples, aspects of the operations of 905 may be performed by a control message component 725 as described with reference to FIG. 7.

At 910, the method may include selecting a second sleep configuration for the channel based on a presence of a frequency spur in one or more frequencies associated with the channel, the second sleep configuration corresponding to a second sleep duration shorter than the first sleep duration. The operations of 910 may be performed in accordance with examples as disclosed herein. In some examples, aspects of the operations of 910 may be performed by a sleep configuration component 730 as described with reference to FIG. 7.

At 915, the method may include monitoring, in an awake state, the channel after the second sleep duration based on the second sleep configuration. The operations of 915 may be performed in accordance with examples as disclosed herein. In some examples, aspects of the operations of 915 may be performed by a monitoring component 735 as described with reference to FIG. 7.

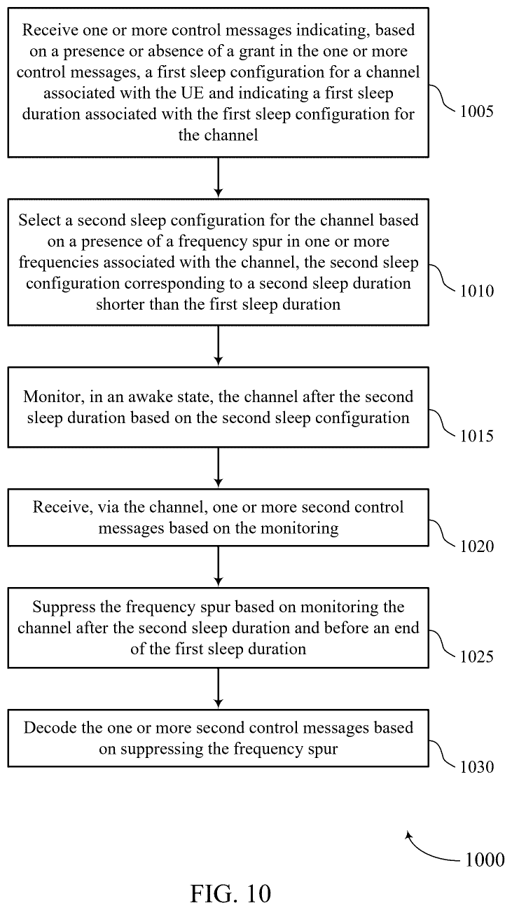

FIG. 10 shows a flowchart illustrating a method 1000 that supports performance improvement at sleep exits for frequency spur channels in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving one or more control messages indicating, based on a presence or absence of a grant in the one or more control messages, a first sleep configuration for a channel associated with the UE and indicating a first sleep duration associated with the first sleep configuration for the channel. The operations of 1005 may be performed in accordance with examples as disclosed herein. In some examples, aspects of the operations of 1005 may be performed by a control message component 725 as described with reference to FIG. 7.

At 1010, the method may include selecting a second sleep configuration for the channel based on a presence of a frequency spur in one or more frequencies associated with the channel, the second sleep configuration corresponding to a second sleep duration shorter than the first sleep duration. The operations of 1010 may be performed in accordance with examples as disclosed herein. In some examples, aspects of the operations of 1010 may be performed by a sleep configuration component 730 as described with reference to FIG. 7.

At 1015, the method may include monitoring, in an awake state, the channel after the second sleep duration based on the second sleep configuration. The operations of 1015 may be performed in accordance with examples as disclosed herein. In some examples, aspects of the operations of 1015 may be performed by a monitoring component 735 as described with reference to FIG. 7.

At 1020, the method may include receiving, via the channel, one or more second control messages based on the monitoring. The operations of 1020 may be performed in accordance with examples as disclosed herein. In some examples, aspects of the operations of 1020 may be performed by a control message component 725 as described with reference to FIG. 7.

At 1025, the method may include suppressing the frequency spur based on monitoring the channel after the second sleep duration and before an end of the first sleep duration. The operations of 1025 may be performed in accordance with examples as disclosed herein. In some examples, aspects of the operations of 1025 may be performed by a frequency spur suppression component 740 as described with reference to FIG. 7.

At 1030, the method may include decoding the one or more second control messages based on suppressing the frequency spur. The operations of 1030 may be performed in accordance with examples as disclosed herein. In some examples, aspects of the operations of 1030 may be performed by a message decoding component 745 as described with reference to FIG. 7.

The following provides an overview of aspects of the present disclosure:

Aspect 1: A method for wireless communications at a UE, comprising: receiving one or more control messages indicating, based at least in part on a presence or absence of a grant in the one or more control messages, a first sleep configuration for a channel associated with the UE and indicating a first sleep duration associated with the first sleep configuration for the channel; selecting a second sleep configuration for the channel based at least in part on a presence of a frequency spur in one or more frequencies associated with the channel, the second sleep configuration corresponding to a second sleep duration shorter than the first sleep duration; and monitoring, in an awake state, the channel after the second sleep duration based at least in part on the second sleep configuration.

Aspect 2: The method of aspect 1, further comprising: receiving, via the channel, one or more second control messages based at least in part on the monitoring; suppressing the frequency spur based at least in part on monitoring the channel after the second sleep duration and before an end of the first sleep duration; and decoding the one or more second control messages based at least in part on suppressing the frequency spur.

Aspect 3: The method of aspect 2, further comprising: obtaining one or more samples of the channel after the second sleep duration and before the end of the first sleep duration, the second sleep duration associated with a sample quantity threshold; and filtering the channel in accordance with the one or more samples, wherein the frequency spur is suppressed based at least in part on the one or more samples satisfying the sample quantity threshold.

Aspect 4: The method of any of aspects 1 through 3, further comprising: disabling a sleep mode of the UE in accordance with the second sleep configuration; and operating in the awake state during an entirety of the first sleep duration based at least in part on disabling the sleep mode in accordance with the second sleep configuration.

Aspect 5: The method of any of aspects 1 through 4, further comprising: receiving one or more messages based at least in part on the monitoring; suppressing a zero-frequency tone based at least in part on monitoring the channel after the second sleep duration and before an end of the first sleep duration; and decoding the one or more messages based at least in part on suppressing the zero-frequency tone.

Aspect 6: The method of any of aspects 1 through 5, wherein the second sleep configuration is selected based at least in part on an SNR, an RSSI value, an aggregation level associated with one or more messages, a magnitude of the frequency spur, channel bandwidth, or any combination thereof, satisfying a threshold.

Aspect 7: The method of any of aspects 1 through 6, wherein the channel is a control channel, and the second sleep configuration is selected based at least in part on an overlap of the frequency spur with the one or more frequencies associated with the control channel.

Aspect 8: A UE for wireless communications, comprising one or more memories storing processor-executable code, and one or more processors coupled with the one or more memories and individually or collectively operable to execute the code to cause the UE to perform a method of any of aspects 1 through 7.

Aspect 9: A UE for wireless communications, comprising at least one means for performing a method of any of aspects 1 through 7.

Aspect 10: A non-transitory computer-readable medium storing code for wireless communications, the code comprising instructions executable by one or more processors to perform a method of any of aspects 1 through 7.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more control messages indicating, based at least in part on a presence or absence of a grant in the one or more control messages, a first sleep configuration for a channel associated with the UE and indicating a first sleep duration associated with the first sleep configuration for the channel;
select a second sleep configuration for the channel based at least in part on a presence of a frequency spur in one or more frequencies associated with the channel, the second sleep configuration corresponding to a second sleep duration shorter than the first sleep duration; and
monitor, in an awake state, the channel after the second sleep duration based at least in part on the second sleep configuration.

2. The UE of claim 1, wherein the one or more processors are individually or collectively further operable to execute the code to cause the UE to:
receive, via the channel, one or more second control messages based at least in part on the monitoring;
suppress the frequency spur based at least in part on monitoring the channel after the second sleep duration and before an end of the first sleep duration; and
decode the one or more second control messages based at least in part on suppressing the frequency spur.

3. The UE of claim 2, wherein the one or more processors are individually or collectively further operable to execute the code to cause the UE to:
obtain one or more samples of the channel after the second sleep duration and before the end of the first sleep duration, the second sleep duration associated with a sample quantity threshold; and
filter the channel in accordance with the one or more samples, wherein the frequency spur is suppressed based at least in part on the one or more samples satisfying the sample quantity threshold.

4. The UE of claim 1, wherein the one or more processors are individually or collectively further operable to execute the code to cause the UE to:
disable a sleep mode of the UE in accordance with the second sleep configuration; and
operate in the awake state during an entirety of the first sleep duration based at least in part on disabling the sleep mode in accordance with the second sleep configuration.

5. The UE of claim 1, wherein the one or more processors are individually or collectively further operable to execute the code to cause the UE to:
receive one or more messages based at least in part on the monitoring;
suppress a zero-frequency tone based at least in part on monitoring the channel after the second sleep duration and before an end of the first sleep duration; and
decode the one or more messages based at least in part on suppressing the zero-frequency tone.

6. The UE of claim 1, wherein the second sleep configuration is selected based at least in part on a signal-to-noise ratio, a received signal strength indicator value, an aggregation level associated with one or more messages, a magnitude of the frequency spur, channel bandwidth, or any combination thereof, satisfying a threshold.

7. The UE of claim 1, wherein:
the channel is a control channel, and
the second sleep configuration is selected based at least in part on an overlap of the frequency spur with the one or more frequencies associated with the control channel.

8. A method for wireless communications at a user equipment (UE), comprising:
receiving one or more control messages indicating, based at least in part on a presence or absence of a grant in the one or more control messages, a first sleep configuration for a channel associated with the UE and indicating a first sleep duration associated with the first sleep configuration for the channel;
selecting a second sleep configuration for the channel based at least in part on a presence of a frequency spur in one or more frequencies associated with the channel, the second sleep configuration corresponding to a second sleep duration shorter than the first sleep duration; and
monitoring, in an awake state, the channel after the second sleep duration based at least in part on the second sleep configuration.

9. The method of claim 8, further comprising:
receiving, via the channel, one or more second control messages based at least in part on the monitoring;
suppressing the frequency spur based at least in part on monitoring the channel after the second sleep duration and before an end of the first sleep duration; and
decoding the one or more second control messages based at least in part on suppressing the frequency spur.

10. The method of claim 9, further comprising:
obtaining one or more samples of the channel after the second sleep duration and before the end of the first sleep duration, the second sleep duration associated with a sample quantity threshold; and
filtering the channel in accordance with the one or more samples, wherein the frequency spur is suppressed based at least in part on the one or more samples satisfying the sample quantity threshold.

11. The method of claim 8, further comprising:
disabling a sleep mode of the UE in accordance with the second sleep configuration; and
operating in the awake state during an entirety of the first sleep duration based at least in part on disabling the sleep mode in accordance with the second sleep configuration.

12. The method of claim 8, further comprising:
receiving one or more messages based at least in part on the monitoring;
suppressing a zero-frequency tone based at least in part on monitoring the channel after the second sleep duration and before an end of the first sleep duration; and
decoding the one or more messages based at least in part on suppressing the zero-frequency tone.

13. The method of claim 8, wherein the second sleep configuration is selected based at least in part on a signal-to-noise ratio, a received signal strength indicator value, an aggregation level associated with one or more messages, a magnitude of the frequency spur, channel bandwidth, or any combination thereof, satisfying a threshold.

14. The method of claim 8, wherein:
the channel is a control channel, and
the second sleep configuration is selected based at least in part on an overlap of the frequency spur with the one or more frequencies associated with the control channel.

15. A non-transitory computer-readable medium storing code for wireless communications, the code comprising instructions executable by one or more processors to:
receive one or more control messages indicating, based at least in part on a presence or absence of a grant in the one or more control messages, a first sleep configuration for a channel associated with a user equipment (UE) and indicating a first sleep duration associated with the first sleep configuration for the channel;
select a second sleep configuration for the channel based at least in part on a presence of a frequency spur in one or more frequencies associated with the channel, the second sleep configuration corresponding to a second sleep duration shorter than the first sleep duration; and
monitor, in an awake state, the channel after the second sleep duration based at least in part on the second sleep configuration.

16. The non-transitory computer-readable medium of claim 15, wherein the instructions are further executable by the one or more processors to:
receive, via the channel, one or more second control messages based at least in part on the monitoring;
suppress the frequency spur based at least in part on monitoring the channel after the second sleep duration and before an end of the first sleep duration; and
decode the one or more second control messages based at least in part on suppressing the frequency spur.

17. The non-transitory computer-readable medium of claim 16, wherein the instructions are further executable by the one or more processors to:
obtain one or more samples of the channel after the second sleep duration and before the end of the first sleep duration, the second sleep duration associated with a sample quantity threshold; and
filter the channel in accordance with the one or more samples, wherein the frequency spur is suppressed based at least in part on the one or more samples satisfying the sample quantity threshold.

18. The non-transitory computer-readable medium of claim 15, wherein the instructions are further executable by the one or more processors to:
disable a sleep mode of the UE in accordance with the second sleep configuration; and
operate in the awake state during an entirety of the first sleep duration based at least in part on disabling the sleep mode in accordance with the second sleep configuration.

19. The non-transitory computer-readable medium of claim 15, wherein the instructions are further executable by the one or more processors to:
receive one or more messages based at least in part on the monitoring;
suppress a zero-frequency tone based at least in part on monitoring the channel after the second sleep duration and before an end of the first sleep duration; and
decode the one or more messages based at least in part on suppressing the zero-frequency tone.

20. The non-transitory computer-readable medium of claim 15, wherein the second sleep configuration is selected based at least in part on a signal-to-noise ratio, a received signal strength indicator value, an aggregation level associated with one or more messages, a magnitude of the frequency spur, channel bandwidth, or any combination thereof, satisfying a threshold.
